(19) United States
(12) Patent Application Publication
(10) Pub. No.: US 2004/0025609 A1
(43) Pub. Date: Feb. 12, 2004

(54) Drive mechanism for a mechanical transmission

(76) Inventors: Thomas Mann, Nidderau (DE); Rajko Colic, Bad Homburg (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/460,220

(22) Filed: Jun. 13, 2003

(30) Foreign Application Priority Data
Jun. 17, 2002 (EP) 02013263.5

(51) Int. Cl. F16H 19/04

(52) U.S. Cl. 74/29

(57) ABSTRACT

An electromechanical drive mechanism is disclosed and includes a driving electromotor provided with a rotatable driving first axis, and mechanical transmission driven by the rotatable driving first axis, for through converting a first rotary movement of the rotatable driving first axis into a second rotary or linear movement of an actuator member driving a mechanical actuator along a range of actuator positions. The drive mechanism is furthermore provided with an forceback facility for effecting a return force on the drive mechanism towards a fallback position. The drive mechanism is furthermore mounted in a housing facility. In particular, the drive mechanism has the forceback facility operated in a mechanical manner and includes a return spring that is arranged for effecting a rotary return force on a rotatable axis that forms part of the mechanical transmission.

### CONTINUATION DATA

The present application claims priority to European patent application number 02013263.5, filed 16.17.2002, which is herein incorporated by reference.

### BACKGROUND OF THE INVENTION

The present invention relates to an electromechanical drive mechanism comprising a driving electromotor provided with a rotatable driving first axis, and mechanical transmission means driven by the rotatable driving first axis, for through converting a first rotary movement of the rotatably driving first axis into a second rotary or linear movement of an actuator member driving a mechanical actuator along a range of actuator positions. The drive mechanism is furthermore provided with a forceback facility for effecting a return force of said drive mechanism towards a fallback position. The drive mechanism is furthermore mounted in a housing facility. Such drive mechanisms are ubiquitous in various fields of application and within a wide range of driving force and power ratings. Among the various advantageous properties of the drive mechanism are its accurate, time-uniform and fine-grained responses.

In applications where a light overall weight is a primary requisite, such as may be the case in motor vehicles, designers will tend to choose low power ratings for the motor. A potential problem then exists when the actuator will, for an extended period of time, be driven at a certain fixed position, but must be returned quasi-instantaneously to a fallback position. The inventors have recognized the potential danger for overload and damage of the electric motor, and also the zero-power quality of mechanical means for various situations including emergency situations effecting stepping, and thereby effectively faster, changes of position. Accordingly a need exists to enhance current drive mechanisms with means for effecting quick rotary motions without overloading the motor.

### SUMMARY OF THE INVENTION

It is an object of the present invention to supplement the advantageous aspects of electrical control with an advantageous complement thereto in the form of mechanical supplementary facilities, so that certain rotary motions can be effected quickly and without danger for electrical overload.

The present invention includes a forceback facility which is operated in a mechanical manner and comprises a return spring that is arranged for effecting a rotary return force on a rotatable axis, the axis forming a part of the mechanical transmission means. Depending on the dimensioning of the electromechanical drive mechanism, the return spring may be operative to on its own, effectively bring about a return motion to the fallback position in the direction of the return force. The pertinent design considerations could include the return being part of an emergency situation, the requirements for low-power operation in the steady and non-moving state, and the self-braking aspects, of the ultimate members of the mechanism.

A drive mechanism that has return springs operating on a throttle drum in an automotive environment has been disclosed in Patent Application EP 0 831 215 A1. Here, the spring action is effected immediately on the actuator itself, i.e., the throttle drum proper. In contradistinction, the serial arrangement of the various parts of the drive mechanism according to the present invention allows for a wide range of operating conditions, a great flexibility in design characteristics, and a fine-tunability of the operation of the mechanism.

Advantageously, the rotary return force is effected on a rotatable second axis that is rotatably engaged with the rotatable first axis. This allows the designer to adroitly adapt the force by the return spring to the amounts of movement and force that must be controlled with respect to the eventual movement of the actuator.

The rotatable second axis may either carry a worm arrangement or a spindle arrangement. The self-braking character of such arrangements may operate to help effecting a motion control of the overall drive mechanism. The topology of the return spring may be that of a spiral. In contradistinction, the return springs of the reference have the topology of a cylindrical screw. The present realization is believed to have advantageous properties regarding the exerted forces and the space necessary for the mechanism.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawings, wherein:

FIG. 1 depicts an overall arrangement of the disclosed embodiment of the present invention;

FIG. 2 depicts a perspective outside view of the principal components of FIG. 1; and

FIG. 3 depicts a perspective view of the return spring in its supporting housing.

### DETAILED DESCRIPTION OF THE INVENTION

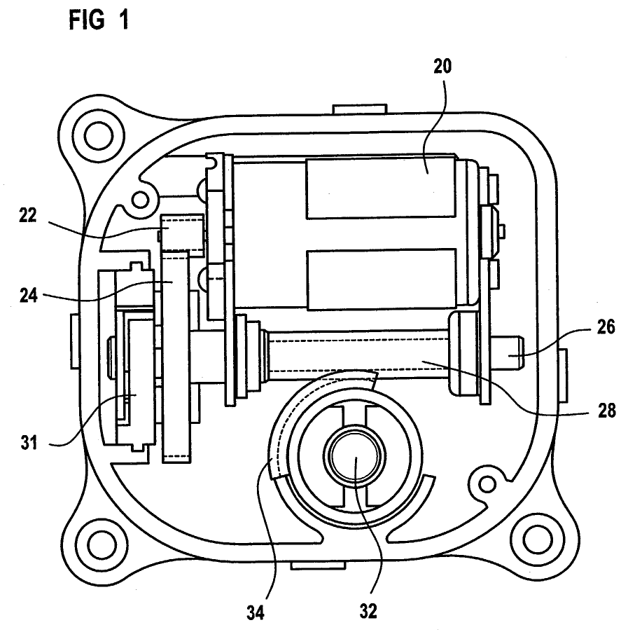

FIG. 1 illustrates an overall arrangement of an embodiment of the present invention. A housing 14 comprising, for example, cast aluminum, may be boltable by appropriate holes to an overall support structure (not shown). The primary driving force for the electromechanical drive mechanism an electric motor 20 which may, without limitation, have a power rating within a range of 5 watts to 1 kilowatt. For brevity and clarity, electric connections as well as the specific type of motor have not been shown. The motor axis carries a small output gearwheel 22, of which the number of teeth is in the order of 10. This output gearwheel engages with a rather larger gearwheel 24 which is mounted on axis 26, and which has a number of teeth in the order of 60. Moreover this latter axis 26 carries a worm 28 that engages with worm gearwheel 34, itself mounted on axis 32 which runs perpendicular to the drawing plane. This latter axis is connected to an actuator (not shown for brevity( which may be used for controlling any of several parameters of a vehicle motor, such as throttle. In particular, but not by way of limitation, such actuator could be used for effecting cruise control.

Furthermore, the arrangement comprises a return spring housed within part 31, and mounted together with gearwheel 24. In particular circumstances, such as emergencies, it may be necessary to return the actuator quasi-instantaneously to a fallback position, to which effect this spring can deliver an appropriate force. The combination of this force and the electrically applied motor force could effectively surpass the performance characteristics of the motor alone. Without such extra force, the motor could effectively be damaged while delivering the required power, even if only for a brief time. Through mounting the return spring on secondary axis 26, the number of rotations to be effectively generated on its “own” axis is less than would have been the case for the motor axis itself. This allows to meticulously adjust the spring force to the motor's.

As a variation, the worm 28 may be replaced by a spindle, that would be arranged to impart on an engaging counterpart member a linear movement in the direction of axis 26. By themselves spindle-based transmissions are well known in the art, and for application with certain types of actuators, such linear movement would be considered superior. For brevity, the spindle embodiment has not been shown explicitly; notably, the set-up of electric motor, first and second gearwheels and return spring could be similar to the setup effectively shown.

As a further variation, the arrangement of the worm and worm-gearwheel combination can be self-braking. This may be applied to heavy load conditions wherein the electric motor cannot move its output gearwheel 22. Such conditions may be detected by means not shown in the Figure. The self-braking maintains the motor without powering in its actual position. This represents a further safety measure against overload damage of the motor. Of course, a similar approach would do in the case of a spindle drive organization. Furthermore, the return spring could be operative for effecting a return movement to the fallback position, or contrariwise, receiving assistance from the electric motor therefor.

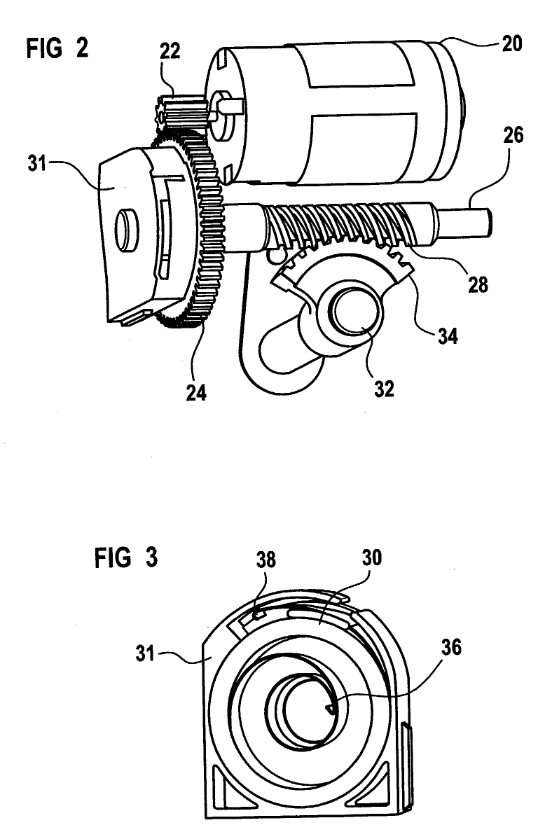

FIG. 2 illustrates a perspective outside view of the principal components of FIG. 1. Certain numerals of FIG. 1 have been copied in to FIG. 2. Electric motor 20, two gearwheels 22, 24, secondary axis 26, worm and worm gearwheel 28, 34, and output axis 32 are depicted. The worm and worm gearwheel combination has been designed for self-operated output braking. In various circumstances, this would render continuous powering of motor 20 superfluous, so that only differential powering were necessary. The return spring arrangement is housed in part 31.

FIG. 3 illustrates a perspective view of the return spring in its supporting housing 31. As shown, the substance of the spring is a rather narrow thin strip that has been wound according to an overall topology of a spiral. Now, whereas the main length of the spring has apparently been wound in multiple and closely spaced windings 30, the two ends 36 and 38 diverge somewhat therefrom and carry half loops or curves for fixing or mounting to axis 26 and to the housing 31, respectively. This allows the spring under appropriate conditions to exert a sufficient amount of force to effect rotary motion of axis 26 and in consequence, also actuator axis 32. For brevity, the fixating of the spring 30 to the housing 31 and axis 26, respectively, have not been shown explicitly.

The concept has been designed for allowing actuator cycles with steady positioning for extended periods of time, that may be terminated by intermittent or fallback control of the overall electromechanical arrangement. By itself, such could represent an overload condition. From another viewpoint, in comparison with such steady positioning, during brief time periods such as during an emergency, the transmission could be used at higher power levels than allowed for the motor, thereby delivering greater actuator power. The construction with a worm arrangement will furthermore allow for a rotation of the output axis, which effectively yields a very low build.

In the above, the present invention has been described with reference to a disclosure and drawings that illustrate a preferred embodiment. Persons skilled in the art would however from inspecting thereof recognize various changes and amendments to such preferred embodiment. For example, instead of using a special type of spiral spring as described above, it is alternatively possible to apply other types of springs (for example a torsion spring) depending on the transmission layout. Therefore, the disclosure herein should be considered by way of example, rather than by way of restriction, and the due scope of the present invention should be determined from the claims appended hereto.

We claim:

1. An electromechanical drive mechanism, comprising:
a motor for driving a wheel in a first axis,
an actuator member mechanically coupled to a mechanical actuator, said actuator member driving said actuator among a plurality of actuator positions,
transmission means mechanically coupled to said motor and actuator member, said transmission means delivering rotational energy from said first axis to said actuator member and comprising at least a second axis having a fallback position,
forceback means mechanically coupled to said second axis, said forceback means comprising a return spring for imparting a force upon said second axis in a direction of said fallback position.

2. The drive mechanism according to claim 1, wherein said second axis is mechanically coupled to said first axis.

3. The drive mechanism according to claim 2, wherein:
said second axis comprises a worm, and
said transmission means further comprises a worm gearwheel for imparting a rotary force upon said worm.

4. The drive mechanism according to claim 3, wherein said worm gearwheel comprises a gearwheel axis which is substantially perpendicular to said first axis.

5. The drive mechanism according to claim 2, further comprising a spindle driven by said second axis.

6. The drive mechanism according to claim 1, wherein said return spring comprises a spiral topology.

7. The drive mechanism according to claim 6, wherein said return spring comprises a band wound around and connected at one end to said second axis.

8. The drive mechanism according to claim 2, further comprising geared wheels mechanically linking said first and second axis.

9. The drive mechanism according to claim 8, wherein said first axis rotates faster than said second axis.

10. The drive mechanism according to claim 3, wherein a combination arrangement of said worm and worm gear is self-braking.

11. The drive mechanism according to claim 5, wherein said spindle is self-braking.

12. The drive mechanism according to claim 1, wherein said forceback means is engagable in emergency situations.

13. The drive mechanism according to claim 1, wherein said second movement is rotary.

14. The drive mechanism according to claim 1, wherein said second movement is linear.
